(19) United States
(12) Patent Application Publication
(10) Pub. No.: US 2017/0278523 A1
(43) Pub. Date: Sep. 28, 2017

(54) METHOD AND DEVICE FOR PROCESSING A VOICE SIGNAL

(71) Applicants: Le Holdings(Beijing)Co. Ltd., Beijing (CN); LE SHI ZHI XIN ELECTRONIC TECHNOLOGY (TIAN JIN) LIMITED, Tianjin (CN)

(72) Inventors: Xianhao ZHAO, Tianjin (CN); Zichao LIU, Tianjin (CN)

(21) Appl. No.: 15/247,841

(22) Filed: Aug. 25, 2016

Related U.S. Application Data
(63) Continuation of application No. PCT/CN2016/088981, filed on Jul. 6, 2016.

(30) Foreign Application Priority Data
Mar. 28, 2016 (CN) 201610184725.X

(51) Int. Cl. G10L 21/028; G10L 25/51

(52) U.S. Cl. CPC G10L 21/028; G10L 25/51; G10L 2021/02165

(57) ABSTRACT

The disclosure provides a method and apparatus for processing a voice signal. The method for processing a voice signal includes: acquiring first voice signals using the at least two voice acquiring devices; determining sound source feature values of the first voice signals acquired by the respective at least two voice acquiring devices; determining a voice processing scheme corresponding to the sound source feature values of the first voice signals acquired by the at least two voice acquiring devices according to a preset first correspondence relationship including a correspondence relationship between a range of source feature values corresponding to the at least two voice acquiring devices and a voice processing scheme; and processing the first voice signals acquired by the at least two voice acquiring devices according to the determined voice processing scheme.

### CROSS-REFERENCE TO RELATED APPLICATIONS

This application is a continuation of International Application No. PCT/CN 2016/088981, filed on Jul. 6, 2016, which is based upon and claims priority to Chinese Patent Application No. 201610184725.X, filed on Mar. 28, 2016, the entire contents of which are incorporated herein by reference.

### TECHNICAL FIELD

The disclosure relates to the field of processing a signal, and particularly to a method and device for processing a voice signal.

### BACKGROUND

In order to improve the quality of a voice application in a mobile phone, many mobile phone manufactures generally improve the quality of the voice application by increasing the number of microphones, and existing terminals with multiple microphones generally include terminals with two microphones, terminals with three microphones, and terminals with four microphones, for all of which one of the microphones is typically configured as a primary microphone, and the other microphones are secondary microphones. The primary microphone is primarily configured to acquire a human voice signal, and the other microphones are primarily configured to acquire noise signals for voice processing to achieve the effect of de-noising.

However in the existing terminals with two microphones, terminals with three microphones, and terminals with four microphones, preset one of the microphones in the terminals operates as the primary microphone for different voice applications. For example, the microphone arranged at the bottom operates as the primary microphone, and the other microphones operate as the secondary microphones, for WeChat voice.

The inventors have identified during making of the invention that the majority of users are currently unaware of a primary microphone preset for a particular application so that the user may communicate using one of the preset secondary microphones of the terminals as a primary microphone, but the secondary microphone is primarily responsible for acquiring ambient noise, so that there may be significant noise in an acquired voice signal of the users for communication.

### SUMMARY

Embodiments of the disclosure provide a method and apparatus for processing a voice signal so as to address the problem in the prior art of significant noise in an acquired voice signal.

In an aspect, embodiments of the disclosure provides a method for processing a voice signal, the method being applicable to a terminal including at least two voice acquiring devices, wherein the method includes:

acquiring first voice signals using the at least two voice acquiring devices;

determining sound source feature values of the first voice signals acquired by the respective at least two voice acquiring devices;

determining a voice processing scheme corresponding to the sound source feature values of the first voice signals acquired by the at least two voice acquiring devices according to a preset first correspondence relationship including a correspondence relationship between a range of source feature values corresponding to the at least two voice acquiring devices and a voice processing scheme; and

processing the first voice signals acquired by the at least two voice acquiring devices according to the determined voice processing scheme.

In another aspect, embodiments of the disclosure provides an electronic device including:

at least one processor; and

a memory communicably connected with the at least one processor for storing instructions executable by the at least one processor, wherein execution of the instructions by the at least one processor causes the at least one processor to:

acquire first voice signals using at least two voice acquiring modules located at different positions in the electronic device;

determine sound source feature values of the first voice signals acquired by the respective at least two voice acquiring modules;

determine a voice processing scheme corresponding to the sound source feature values of the first voice signals acquired by the at least two voice acquiring modules, according to a preset first correspondence relationship comprising a correspondence relationship between a range of source feature values corresponding to the at least two voice acquiring modules and a voice processing scheme; and

process the first voice signals acquired by the at least two voice acquiring modules according to the determined voice processing scheme.

In a further aspect, embodiments of the disclosure provides a non-transitory computer-readable storage medium storing executable instructions that, when executed by an electronic device, cause the electronic device to:

acquire first voice signals using at least two voice acquiring modules located at different positions in the electronic device;

determine sound source feature values of the first voice signals acquired by the respective at least two voice acquiring modules;

determine a voice processing scheme corresponding to the sound source feature values of the first voice signals acquired by the at least two voice acquiring modules, according to a preset first correspondence relationship comprising a correspondence relationship between a range of source feature values corresponding to the at least two voice acquiring modules and a voice processing scheme; and

process the first voice signals acquired by the at least two voice acquiring modules according to the determined voice processing scheme.

With the method and apparatus for processing a voice signal according to the embodiments of the disclosure, the sound source feature values of the first voice signals acquired by the respective at least two voice acquiring devices are determined; and then the voice processing scheme corresponding to the sound source feature values of the first voice signals acquired by the at least two voice acquiring devices is determined, and the first voice signals acquired by the at least two voice acquiring devices are processed according to the determined voice processing scheme. Since the correspondence relationship between a range of sound source feature values corresponding to the at least two voice acquiring devices and a voice processing scheme is preset, the optimum voice processing scheme matching the sound source feature values can be determined, and the optimum input and outputting device can be switched to achieve the effect of de-noising to thereby provide a user with a better experience of sound, and alleviating the user from operating improperly without any knowledge of the position of a primary microphone in the terminal.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for processing a voice signal in accordance with some embodiments;

FIG. 2 is a structural diagram of an apparatus for processing a voice signal in accordance with some embodiments; and

FIG. 3 is a schematic diagram of an electronic device for processing a voice signal in accordance with some embodiments.

### DETAILED DESCRIPTION

In order to make the objects, technical solutions, and advantages of the embodiments of the disclosure more apparent, the technical solutions according to the embodiments of the disclosure will be described below clearly and fully with reference to the drawings in the embodiments of the disclosure, and apparently the embodiments described below are only a part but not all of the embodiments of the disclosure. Based upon the embodiments here of the disclosure, all the other embodiments which can occur to those skilled in the art without any inventive effort shall fall into the scope of the disclosure.

Since de-noising in a mobile phone equipped with two, three or fourth microphones is proposed for communication scenarios or various voice based applications, e.g., various applications installed on mobile phones, e.g., WeChat, voice chatting in QQ, interphone applications, voice recording applications, voice notebooks, etc., different applications correspond to respective primary microphones, and the other microphones are configured for de-noising. However if some application operates with a preset primary microphone, and the user is unaware of the primary microphone for the application, then the user may communicate using one of the preset secondary microphones of the terminal as the primary microphone, but the secondary microphone is primary responsible for acquiring ambient noise, thus degrading the effectiveness of de-noising. In view of this, the following technical solutions to be described below have been proposed, but the disclosure will not be limited the respective embodiments thereof to be described below.

Embodiments of the disclosure provide a method and apparatus for processing a voice signal so as to address the problem in the prior art of significant noise in an acquired voice signal. Since the method and the apparatus based upon the same inventive idea address the problem under a similar principle, reference can be made to the embodiment of the method for an embodiment of the apparatus, and vice versa, so a repeated description thereof will be omitted here.

An embodiment of the disclosure provides a method for processing a voice signal, the method being applicable to a terminal including at least two voice acquiring devices arranged at different positions in the terminal. The voice acquiring devices can be microphones, but the embodiment of the disclosure will not be limited to microphones, and the voice acquiring devices can alternatively be earphones.

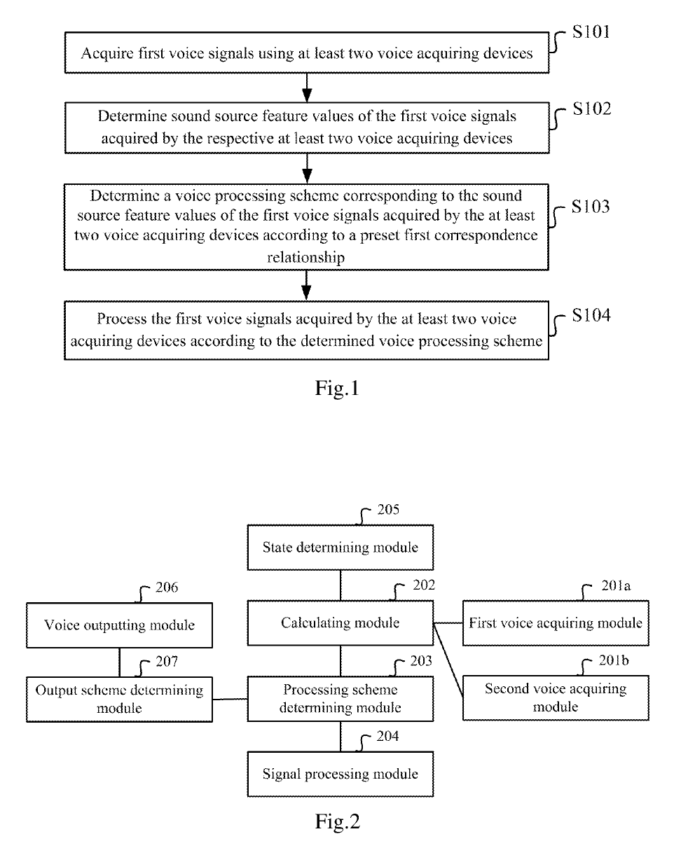

As illustrated in FIG. 1, the method includes:

S101 is to acquire first voice signals using the at least two voice acquiring devices;

S102 is to determine sound source feature values of the first voice signals acquired by the respective at least two voice acquiring devices;

S103 is to determine a voice processing scheme corresponding to the sound source feature values of the first voice signals acquired by the at least two voice acquiring devices according to a preset first correspondence relationship;

The preset first correspondence relationship includes a correspondence relationship between a range of source feature values corresponding to the at least two voice acquiring devices and a voice processing scheme; and

S104 is to process the first voice signals acquired by the at least two voice acquiring devices according to the determined voice processing scheme.

Optionally the sound source feature values of the first voice signals acquired by the respective at least two voice acquiring devices can be determined by determining periodically the sound source feature values of the first voice signals acquired by the respective at least two voice acquiring devices so that the voice processing scheme corresponding to the sound source feature values of the first voice signals acquired by the at least two voice acquiring devices is determined periodically according to the preset first correspondence relationship to thereby avoid the voice processing scheme from being switched frequently.

Optionally the voice processing scheme corresponding to the sound source feature values of the first voice signals acquired by the at least two voice acquiring devices can be determined according to the preset first correspondence relationship in the following implementations without any limitation thereto.

First Implementation

The voice acquiring device with the largest one of the acquired sound source feature values of the first voice signals among the at least two voice acquiring devices is selected to acquire a voice signal of a primary sound source, and the other voice acquiring devices acquire external ambient noise.

Taking two voice acquiring devices as an example, if sound source feature values of the two voice acquiring devices are represented respectively as MKF1 and MKF2, then the first correspondence relationship can be created as depicted in Table 1.

TABLE 1

| | |
|---|---|
| MKF1 > MKF2 | MKF1 acquires a voice signal of a primary sound |
| | source, and MKF2 acquires external ambient noise |
| MKF1 <= MKF2 | MKF2 acquires a voice signal of a primary sound |
| | source, and MKF1 acquires external ambient noise |

In this technical solution, the at least two voice acquiring devices can be a plurality of microphones, and if a user communicates voice normally using the microphone located at the lower end of the terminal, then the microphone at the lower end of the terminal may be primarily configured to acquire voice of the speaking user, and the microphone at another position in the terminal may be primarily configured to acquire external ambient noise, so that the external ambient noise acquired by the microphone at the other position in the terminal can be filtered out of the voice acquired by the microphone at the lower end of the terminal, thus resulting in clear voice of the user to achieve the effect of de-noising.

Second Implementation

Two voice acquiring devices with the largest ones of the acquired sound source feature values of the first voice signals among the at least two voice acquiring devices are selected to acquire a voice signal of a primary sound source, and the other voice acquiring devices acquire external ambient noise.

The second implementation is applicable to a terminal including three or more voice acquiring devices.

Optionally the first voice signals acquired by the at least two voice acquiring devices can be processed according to the determined voice processing scheme as follows:

If it is determined that the currently determined voice processing scheme is different from the lastly determined voice processing scheme, and the currently determined voice processing scheme has been applied for a length of time reaching a preset length of time threshold, then the first voice signals acquired by the at least two voice acquiring devices can be processed according to the currently determined voice processing scheme.

For example, a user operates on WeChat initially using the microphone at the lower end of the terminal as a primary microphone to acquire voice generated by the user, and the other microphones acquire ambient noise, but if the operating user changes his or her posture while speaking so that he or she has kept on speaking to the microphone at the upper end of the terminal for a length of time reaching a preset length of time threshold, then the microphone at the upper end of the terminal can be changed to a primary microphone to acquire voice generated by the user, and the other microphones acquire ambient noise.

Optionally if it is determined that the currently determined voice processing scheme is different from the lastly determined voice processing scheme, and the currently determined voice processing scheme has been not applied for a length of time reaching the preset length of time threshold, then the first voice signals acquired by the at least two voice acquiring devices can be processed according to the lastly determined voice processing scheme.

In this implementation, the voice processing scheme can be avoided from being switched frequently. For example, if the calling user passing a noisy environment stays in the noisy environment for a short period of time, then the voice processing scheme may not be switched.

Optionally before the sound source feature values of the first voice signals acquired by the respective at least two voice acquiring devices are determined, the method further includes:

It is determined that a voice processing mode in which the voice processing scheme is selected automatically is enabled.

If it is determined that the voice processing mode in which the voice processing scheme is selected automatically is disabled, then the sound source feature values of the first voice signals may not be further determined, and the voice processing scheme may not be further determined as in the embodiment of the disclosure, but the first voice signals may be processed as in the prior art, for example, corresponding voice processing schemes may be applied to different applications.

Optionally the embodiment of the disclosure can be further applicable to a voice outputting device. The terminal includes at least one voice outputting device.

If at least one voice outputting device outputs a second voice signal, then third voice signals including at least the second voice signal may be acquired by the at least two voice acquiring devices;

Sound source feature values of the third voice signals acquired by the respective at least two voice acquiring devices are determined;

A voice output scheme corresponding to the sound source feature values of the third voice signals acquired by the at least two voice acquiring devices is determined according to a preset second correspondence relationship, where the preset second correspondence relationship includes a correspondence relationship between a range of source feature values corresponding to the at least two voice acquiring devices and a voice output scheme; and

The at least one voice outputting device is controlled according to the determined output processing scheme to output the second voice signal.

In an embodiment of the disclosure, the voice outputting device can be a speaker. For example, while the speaker is playing music, then if there is other loud sound acquired by the at least two voice acquiring devices in addition to the music, then a volume at which the music is played may be adjusted up. For example, if the terminal including two speakers pre-stores therein the distances between the at least two voice acquiring devices and the two speakers, then while music is being played, if there is significant noise acquired by the at least two voice acquiring devices in addition to the music, but louder noise acquired by the voice acquiring device close to the left sound channel, then the volume of the right sound channel may be adjusted up while adjusting down the volume of the left sound channel

With the implementations according to the embodiment of the disclosure, the optimum voice processing scheme matching the sound source feature values of the voice signals acquired by the voice acquiring devices can be determined, and the optimum input and outputting device can be switched to achieve the effect of de-noising to thereby provide the user with a better experience of sound, and alleviating the user from operating improperly without any knowledge of the position of the primary microphone in the terminal.

Based upon the same inventive idea, an embodiment of the disclosure further provides an apparatus for processing a voice signal, and since the apparatus addresses the problem under a similar principle to the method, reference can be made for the implementation of the method for an implementation of the apparatus, so a repeated description thereof will be omitted here.

An embodiment of the disclosure further provides an apparatus for processing a voice signal, the apparatus being applicable to a terminal. As illustrated in FIG. 2, the apparatus includes:

At least two voice acquiring modules, for example, which are a first voice acquiring module 201a and a second voice acquiring module 201b in the embodiment of the disclosure. The first voice acquiring module 201a and the second voice acquiring module 201b are configured respectively to acquire first voice signals;

The first voice acquiring module and the second voice acquiring module are located at different positions in the terminal;

A calculating module 202 is configured to determine sound source feature values of the first voice signals acquired respectively by the first voice acquiring module 201a and the second voice acquiring module 201b;

A processing scheme determining module 203 is configured to determine a voice processing scheme corresponding to the sound source feature values, determined by the calculating module 202, of the first voice signals acquired respectively by the first voice acquiring module 201a and the second voice acquiring module 201b, according to a preset first correspondence relationship, where the preset first correspondence relationship includes a correspondence relationship between a range of source feature values corresponding to the first voice acquiring module 201a and the second voice acquiring module 201b, and a voice processing scheme; and

A signal processing module 204 is configured to process the first voice signals acquired by the first voice acquiring module 201a and the second voice acquiring module 201b according to the voice processing scheme determined by the processing scheme determining module 203.

Optionally the processing scheme determining module 203 is configured to select the voice acquiring module with the largest one of the sound source feature values among the first voice acquiring module 201a and the second voice acquiring module 201b as a primary device configured to acquire a voice signal of a primary sound source while the other voice acquiring module is a secondary device configured to acquire ambient noise.

Optionally the calculating module 202 is configured:

To determine periodically the sound source feature values of the first voice signals acquired by the respective at least two voice acquiring modules.

Optionally the signal processing module 204 is configured:

If it is determined that the currently determined voice processing scheme is different from the lastly determined voice processing scheme, and the currently determined voice processing scheme has been applied for a length of time reaching a preset length of time threshold, to process the first voice signals acquired by the first voice acquiring module 201a and the second voice acquiring module 201b according to the currently determined voice processing scheme.

Optionally the apparatus further includes:

A state determining module 205 is configured to determine that a voice processing mode in which the voice processing scheme is selected automatically is enabled, before the calculating module 202 determines the sound source feature values of the first voice signals acquired respectively by the first voice acquiring module 201a and the second voice acquiring module 201b.

The apparatus can further include:

At least one voice outputting module 206 is configured to output a second voice signal;

The first voice acquiring module 201a and the second voice acquiring module 201b are further configured to acquire third voice signals including at least the second voice signal while the at least one voice outputting module is outputting the second voice signal;

The calculating module 202 is further configured to determine sound source feature values of the third voice signals acquired respectively by the first voice acquiring module 201a and the second voice acquiring module 201b;

An output scheme determining module 207 is configured to determine a voice output scheme corresponding to the sound source feature values of the third voice signals acquired respectively by the first voice acquiring module 201a and the second voice acquiring module 201b according to a preset second correspondence relationship, where the preset second correspondence relationship includes a correspondence relationship between a range of source feature values corresponding to the first voice acquiring module 201a and the second voice acquiring module 201b, and a voice output scheme; and

A controlling module is configured to control the at least one voice outputting module 206 according to the determined voice output scheme to output the second voice signal.

For the sake of a convenient description, the respective components above have been functionally described respectively as the respective modules (or units). Of course, in an implementation of the disclosure, the functions of the respective modules (or units) can be performed in the same one or more pieces of software or hardware. In a particular implementation, the apparatus for processing a voice signal can be arranged in a server.

The relevant functional modules other than the voice acquiring module illustrated in FIG. 2 can be embodied by a hardware processor in an embodiment of the disclosure. Particularly an apparatus for processing a voice signal according to an embodiment of the disclosure includes a memory, a processor, and at least two voice acquiring devices, where the processor is configured to read program in the memory, and to perform the process of: acquiring a first voice signals using the at least two voice acquiring devices; determining sound source feature values of the first voice signals acquired by the respective at least two voice acquiring devices; determining a voice processing scheme corresponding to the sound source feature values of the first voice signals acquired by the at least two voice acquiring devices according to a preset first correspondence relationship including a correspondence relationship between a range of source feature values corresponding to the at least two voice acquiring devices, and a voice processing scheme; and processing the first voice signals acquired by the at least two voice acquiring devices according to the determined voice processing scheme.

The embodiments of the apparatus described above are merely exemplary, where the units described as separate components may or may not be physically separate, and the components illustrated as elements may or may not be physical units, that is, they can be collocated or can be distributed onto a number of network elements. A part or all of the modules can be selected as needed in reality for the purpose of the solution according to the embodiments of the disclosure. This can be understood and practiced by those ordinarily skilled in the art without any inventive effort.

With the implementations according to the embodiments of the disclosure, the optimum voice processing scheme matching the sound source feature values of the voice signals acquired by the voice acquiring devices can be determined, and the optimum input and outputting device can be switched to achieve the effect of de-noising to thereby provide the user with a better experience of sound, and alleviating the user from operating improperly without any knowledge of the position of the primary microphone in the terminal.

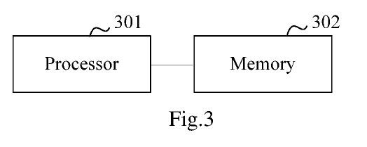

Based upon the same inventive idea, an embodiment of the disclosure further provides an electronic device for processing a voice signal, as illustrated in FIG. 3, which includes:

At least one processor 301 and a memory 302, where there is one processor as an example in FIG. 3.

The memory 302 is communicably connected with the at least one processor for storing instructions executable by the at least one processor, wherein execution of the instructions by the at least one processor causes the at least one processor to:

Acquire first voice signals using at least two voice acquiring modules located at different positions in the electronic device;

Determine sound source feature values of the first voice signals acquired by the respective at least two voice acquiring modules;

Determine a voice processing scheme corresponding to the sound source feature values of the first voice signals acquired by the at least two voice acquiring modules, according to a preset first correspondence relationship comprising a correspondence relationship between a range of source feature values corresponding to the at least two voice acquiring modules and a voice processing scheme; and

Process the first voice signals acquired by the at least two voice acquiring modules according to the determined voice processing scheme.

In one embodiment, the execution of the instructions by the at least one processor further causes the at least one processor to:

Select the voice acquiring module with the largest one of the sound source feature values among the at least two voice acquiring modules as a primary device configured to acquire a voice signal of a primary sound source while the other voice acquiring modules are secondary devices configured to acquire ambient noise.

In one embodiment, the execution of the instructions by the at least one processor further causes the at least one processor to:

If it is determined that the currently determined voice processing scheme is different from the lastly determined voice processing scheme, and the currently determined voice processing scheme has been applied for a length of time reaching a preset length of time threshold, process the first voice signals acquired by the at least two voice acquiring modules according to the currently determined voice processing scheme.

In one embodiment, the execution of the instructions by the at least one processor further causes the at least one processor to:

Determine that a voice processing mode in which the voice processing scheme is selected automatically is enabled, before determining the sound source feature values of the first voice signals acquired by the respective at least two voice acquiring modules.

In one embodiment, the execution of the instructions by the at least one processor further causes the at least one processor to:

If at least one voice outputting module of the electronic device outputs a second voice signal, acquire third voice signals including at least the second voice signal using the at least two voice acquiring devices;

Determine sound source feature values of the third voice signals acquired by the respective at least two voice acquiring modules;

Determine a voice output scheme corresponding to the sound source feature values of the third voice signals acquire by the respective at least two voice acquiring modules according to a preset second correspondence relationship comprising a correspondence relationship between a range of source feature values corresponding to the at least two voice acquiring modules and a voice output scheme; and

Control the at least one voice outputting module according to the determined voice output scheme to output the second voice signal.

Based upon the same inventive idea, an embodiment of the disclosure further provides a non-transitory computer-readable storage medium storing executable instructions that, when executed by an electronic device, cause the electronic device to:

Acquire first voice signals using at least two voice acquiring modules located at different positions in the electronic device;

Determine sound source feature values of the first voice signals acquired by the respective at least two voice acquiring modules;

Determine a voice processing scheme corresponding to the sound source feature values of the first voice signals acquired by the at least two voice acquiring modules, according to a preset first correspondence relationship comprising a correspondence relationship between a range of source feature values corresponding to the at least two voice acquiring modules and a voice processing scheme; and

Process the first voice signals acquired by the at least two voice acquiring modules according to the determined voice processing scheme.

In one embodiment, the executable instructions executed by the electronic device further cause the electronic device to:

Select the voice acquiring module with the largest one of the sound source feature values among the at least two voice acquiring modules as a primary device configured to acquire a voice signal of a primary sound source while the other voice acquiring modules are secondary devices configured to acquire ambient noise.

In one embodiment, the executable instructions executed by the electronic device further cause the electronic device to:

If it is determined that the currently determined voice processing scheme is different from the lastly determined voice processing scheme, and the currently determined voice processing scheme has been applied for a length of time reaching a preset length of time threshold, process the first voice signals acquired by the at least two voice acquiring modules according to the currently determined voice processing scheme.

In one embodiment, the executable instructions executed by the electronic device further cause the electronic device to:

Determine that a voice processing mode in which the voice processing scheme is selected automatically is enabled, before determining the sound source feature values of the first voice signals acquired by the respective at least two voice acquiring modules.

In one embodiment, the executable instructions executed by the electronic device further cause the electronic device to:

If at least one voice outputting module of the electronic device outputs a second voice signal, acquire third voice signals including at least the second voice signal using the at least two voice acquiring devices;

Determine sound source feature values of the third voice signals acquired by the respective at least two voice acquiring modules;

Determine a voice output scheme corresponding to the sound source feature values of the third voice signals acquire by the respective at least two voice acquiring modules according to a preset second correspondence relationship comprising a correspondence relationship between a range of source feature values corresponding to the at least two voice acquiring modules and a voice output scheme; and

Control the at least one voice outputting module according to the determined voice output scheme to output the second voice signal.

The electronic device according to some embodiments of the disclosure can be in multiple forms, which include but not limit to:

1. Mobile communication device, of which characteristic has mobile communication function, and briefly acts to provide voice and data communication. These terminals include smart phone (i.e. iPhone), multimedia mobile phone, feature phone, cheap phone and etc.

2. Ultra mobile personal computing device, which belongs to personal computer, and has function of calculation and process, and has mobile networking function in general. These terminals include PDA, MID, UMPC (Ultra Mobile Personal Computer) and etc.

3. Portable entertainment equipment, which can display and play multimedia contents. These equipments include audio player, video player (e.g. iPod), handheld game player, electronic book, hobby robot and portable vehicle navigation device.

4. Server, which provides computing services, and includes processor, hard disk, memory, system bus and etc. The framework of the server is similar to the framework of universal computer, however, there is a higher requirement for processing capacity, stability, reliability, safety, expandability, manageability and etc due to supply of high reliability services.

5. Other electronic devices having data interaction function.

The embodiments of the apparatus described above are merely exemplary, where the units described as separate components may or may not be physically separate, and the components illustrated as elements may or may not be physical units, that is, they can be collocated or can be distributed onto a number of network elements. A part or all of the modules can be selected as needed in reality for the purpose of the solution according to the embodiments of the disclosure. This can be understood and practiced by those ordinarily skilled in the art without any inventive effort.

Those skilled in the art can clearly appreciate from the foregoing description of the embodiments that the embodiments of the disclosure can be implemented in hardware or in software plus a necessary general hardware platform. Based upon such understanding, the technical solutions above essentially or their parts contributing to the prior art can be embodied in the form of a computer software product which can be stored in a computer readable storage medium, e.g., an ROM/RAM, a magnetic disk, an optical disk, etc., and which includes several instructions to cause a computer device (e.g., a personal computer, a server, a network device, etc.) to perform the method according to the respective embodiments of the disclosure.

Lastly it shall be noted that the embodiments above are merely intended to illustrate but not to limit the technical solution of the disclosure; and although the disclosure has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the disclosure as claimed.

What is claimed is:

1. A method for processing a voice signal, the method being applicable to a terminal including at least two voice acquiring devices arranged at different positions in the terminal, wherein the method comprises:
acquiring first voice signals using the at least two voice acquiring devices;
determining sound source feature values of the first voice signals acquired by the respective at least two voice acquiring devices;
determining a voice processing scheme corresponding to the sound source feature values of the first voice signals acquired by the at least two voice acquiring devices, according to a preset first correspondence relationship comprising a correspondence relationship between a range of source feature values corresponding to the at least two voice acquiring devices and a voice processing scheme; and
processing the first voice signals acquired by the at least two voice acquiring devices according to the determined voice processing scheme.

2. The method according to claim 1, wherein determining the voice processing scheme corresponding to the sound source feature values of the first voice signals acquired by the at least two voice acquiring devices according to the preset first correspondence relationship comprises:
selecting the voice acquiring device with the largest one of the sound source feature values among the at least two voice acquiring devices as a primary device configured to acquire a voice signal of a primary sound source while the other at least two voice acquiring devices are secondary devices configured to acquire ambient noise.

3. The method according to claim 1, wherein processing the first voice signals acquired by the at least two voice acquiring devices according to the determined voice processing scheme comprises:
if it is determined that the currently determined voice processing scheme is different from the lastly determined voice processing scheme, and the currently determined voice processing scheme has been applied for a length of time reaching a preset length of time threshold, then processing the first voice signals acquired by the at least two voice acquiring devices according to the currently determined voice processing scheme.

4. The method according to claim 2, wherein processing the first voice signals acquired by the at least two voice acquiring devices according to the determined voice processing scheme comprises:
if it is determined that the currently determined voice processing scheme is different from the lastly determined voice processing scheme, and the currently determined voice processing scheme has been applied for a length of time reaching a preset length of time threshold, then processing the first voice signals acquired by the at least two voice acquiring devices according to the currently determined voice processing scheme.

5. The method according to claim 1, wherein before determining the sound source feature values of the first voice signals acquired by the respective at least two voice acquiring devices the method comprises:
determining that a voice processing mode in which the voice processing scheme is selected automatically is enabled.

6. The method according to claim 1, wherein the method further comprises:
if at least one voice outputting device outputs a second voice signal, then acquiring third voice signals comprising at least the second voice signal using the at least two voice acquiring devices;
determining sound source feature values of the third voice signals acquired by the respective at least two voice acquiring devices;
determining a voice output scheme corresponding to the sound source feature values of the third voice signals acquire by the at least two voice acquiring devices according to a preset second correspondence relationship comprising a correspondence relationship between a range of source feature values corresponding to the at least two voice acquiring devices and a voice output scheme; and
controlling the at least one voice outputting device according to the determined voice output scheme to output the second voice signal.

7. An electronic device, comprising:
at least one processor; and
a memory communicably connected with the at least one processor for storing instructions executable by the at least one processor, wherein execution of the instructions by the at least one processor causes the at least one processor to:
acquire first voice signals using at least two voice acquiring modules located at different positions in the electronic device;
determine sound source feature values of the first voice signals acquired by the respective at least two voice acquiring modules;
determine a voice processing scheme corresponding to the sound source feature values of the first voice signals acquired by the at least two voice acquiring modules, according to a preset first correspondence relationship comprising a correspondence relationship between a range of source feature values corresponding to the at least two voice acquiring modules and a voice processing scheme; and
process the first voice signals acquired by the at least two voice acquiring modules according to the determined voice processing scheme.

8. The electronic device according to claim 7, wherein the execution of the instructions by the at least one processor further causes the at least one processor to:
select the voice acquiring module with the largest one of the sound source feature values among the at least two voice acquiring modules as a primary device configured to acquire a voice signal of a primary sound source while the other voice acquiring modules are secondary devices configured to acquire ambient noise.

9. The electronic device according to claim 7, wherein the execution of the instructions by the at least one processor further causes the at least one processor to:
if it is determined that the currently determined voice processing scheme is different from the lastly determined voice processing scheme, and the currently determined voice processing scheme has been applied for a length of time reaching a preset length of time threshold, process the first voice signals acquired by the at least two voice acquiring modules according to the currently determined voice processing scheme.

10. The electronic device according to claim 8, wherein the execution of the instructions by the at least one processor further causes the at least one processor to:
if it is determined that the currently determined voice processing scheme is different from the lastly determined voice processing scheme, and the currently determined voice processing scheme has been applied for a length of time reaching a preset length of time threshold, process the first voice signals acquired by the at least two voice acquiring modules according to the currently determined voice processing scheme.

11. The electronic device according to claim 7, wherein the execution of the instructions by the at least one processor further causes the at least one processor to:
determine that a voice processing mode in which the voice processing scheme is selected automatically is enabled, before determining the sound source feature values of the first voice signals acquired by the respective at least two voice acquiring modules.

12. The electronic device according to claim 7, wherein the execution of the instructions by the at least one processor further causes the at least one processor to:
if at least one voice outputting module of the electronic device outputs a second voice signal, acquire third voice signals including at least the second voice signal using the at least two voice acquiring devices;
determine sound source feature values of the third voice signals acquired by the respective at least two voice acquiring modules;
determine a voice output scheme corresponding to the sound source feature values of the third voice signals acquire by the respective at least two voice acquiring modules according to a preset second correspondence relationship comprising a correspondence relationship between a range of source feature values corresponding to the at least two voice acquiring modules and a voice output scheme; and
control the at least one voice outputting module according to the determined voice output scheme to output the second voice signal.

13. A non-transitory computer-readable storage medium storing executable instructions that, when executed by an electronic device, cause the electronic device to:
acquire first voice signals using at least two voice acquiring modules located at different positions in the electronic device;
determine sound source feature values of the first voice signals acquired by the respective at least two voice acquiring modules;
determine a voice processing scheme corresponding to the sound source feature values of the first voice signals acquired by the at least two voice acquiring modules, according to a preset first correspondence relationship comprising a correspondence relationship between a range of source feature values corresponding to the at least two voice acquiring modules and a voice processing scheme; and
process the first voice signals acquired by the at least two voice acquiring modules according to the determined voice processing scheme.

14. The non-transitory computer-readable storage medium according to claim 13, wherein the executable instructions executed by the electronic device further cause the electronic device to:
select the voice acquiring module with the largest one of the sound source feature values among the at least two voice acquiring modules as a primary device configured to acquire a voice signal of a primary sound source while the other voice acquiring modules are secondary devices configured to acquire ambient noise.

15. The non-transitory computer-readable storage medium according to claim 13, wherein the executable instructions executed by the electronic device further cause the electronic device to:
if it is determined that the currently determined voice processing scheme is different from the lastly determined voice processing scheme, and the currently determined voice processing scheme has been applied for a length of time reaching a preset length of time threshold, process the first voice signals acquired by the at least two voice acquiring modules according to the currently determined voice processing scheme.

16. The non-transitory computer-readable storage medium according to claim 14, wherein the executable instructions executed by the electronic device further cause the electronic device to:
if it is determined that the currently determined voice processing scheme is different from the lastly determined voice processing scheme, and the currently determined voice processing scheme has been applied for a length of time reaching a preset length of time threshold, process the first voice signals acquired by the at least two voice acquiring modules according to the currently determined voice processing scheme.

17. The non-transitory computer-readable storage medium according to claim 13, wherein the executable instructions executed by the electronic device further cause the electronic device to:
determine that a voice processing mode in which the voice processing scheme is selected automatically is enabled, before determining the sound source feature values of the first voice signals acquired by the respective at least two voice acquiring modules.

18. The non-transitory computer-readable storage medium according to claim 13, wherein the executable instructions executed by the electronic device further cause the electronic device to:
if at least one voice outputting module of the electronic device outputs a second voice signal, acquire third voice signals including at least the second voice signal using the at least two voice acquiring devices;
determine sound source feature values of the third voice signals acquired by the respective at least two voice acquiring modules;
determine a voice output scheme corresponding to the sound source feature values of the third voice signals acquire by the respective at least two voice acquiring modules according to a preset second correspondence relationship comprising a correspondence relationship between a range of source feature values corresponding to the at least two voice acquiring modules and a voice output scheme; and
control the at least one voice outputting module according to the determined voice output scheme to output the second voice signal.
